(19) United States
(12) Patent Application Publication
(10) Pub. No.: US 2025/0116631 A1
(43) Pub. Date: Apr. 10, 2025

(54) CONCENTRATOR FOR INSPECTING DEFECTS IN A FERROMAGNETIC OBJECT

(71) Applicant: Oceaneering International, Inc., Houston, TX (US)

(72) Inventors: Nitika GARG, Panchkula (IN); Soumya CHAKRABORTY, Panchkula (IN); Vikrant VERMA, Haryana (IN)

(73) Assignee: Oceaneering International, Inc., Houston, TX (US)

(21) Appl. No.: 18/910,339

(22) Filed: Oct. 9, 2024

(30) Foreign Application Priority Data
Oct. 9, 2023 (IN) 202311067612

(51) Int. Cl. G01N 27/82

(52) U.S. Cl. CPC G01N 27/82

(57) ABSTRACT

Concentrator for detecting defects in a ferromagnetic object comprises flux concentrator, typically fixed in a center of the device, which has two or more magnet assemblies disposed at each end of flux concentrator for saturating the ferromagnetic object passing through the device or where device is passing over the ferromagnetic object. Leaked flux emanated from the ferromagnetic objects due to defects in the ferromagnetic object is captured by the flux concentrator and channelized onto sensors embedded in the flux concentrator. Data gathered by the sensors may be processed for exploring nature and characteristics of the defects in the ferromagnetic object.

### CROSS-REFERENCE TO RELATED APPLICATIONS

This application claims priority through India Provisional Application 202311067612 filed on Oct. 9, 2023.

### BACKGROUND

Magnetic flux leakage is typically used for the Non-Destructive Testing (NDT) of remotely operated vehicle (ROV) umbilicals, typically by saturating umbilical armor wire with magnetic field lines using strong rare earth magnets. Umbilicals are provided with armor wires consisting of communication signal cables and power cables for ROV functionality. The outer two layers of a typical umbilical are made up of grade 34 steel which are used to provide strength and shielding to the inner functional wires and all the layers are fixed together in a twisted fashion. The magnetic flux leaked from defects in the armor wire is captured and measured using Hall effect sensors. The armor wires, helically wound in a cylindrical fashion, are generally inspected using an array of Hall effect sensors such that no defect in any position at a coverage of 360° around the umbilical goes undetected. The data collected from all the sensors is then processed and deciphered.

The number of sensors is challenging to handle, leading to an increase in the number of failure modes, an increase in cost of data acquisition unit, and discontinuity in the signal acquisition circumferentially. Also, most currently comparable sensing arrangements have the capability of detecting only local fault but not the loss of metallic area.

### BRIEF DESCRIPTION OF THE DRAWINGS

Various figures are included herein which illustrate aspects of embodiments of the disclosed invention.

FIG. 1 illustrates a perspective view of an exemplary concentrator for inspecting defects;

FIG. 2 illustrates an exploded view of a flux concentrator of an exemplary concentrator for inspecting defects;

FIG. 3 illustrates a schematic representation of the concentrator of the exemplary concentrator for inspecting defects;

FIG. 4 illustrates a schematic representation of the concentrator of the exemplary concentrator for inspecting defects;

FIG. 5 illustrates a perspective view of the exemplary concentrator for inspecting defects; and

FIG. 6 illustrates a block diagram of data acquisition and processing system incorporating the exemplary concentrator for inspecting defects.

### DESCRIPTION OF EXEMPLARY EMBODIMENTS

As used herein, ferromagnetic objects 112 specifically include elongated ferromagnetic objects 112 such as, but not limited to, wire ropes, pipes, cables, umbilicals, mooring chains, and the like, or a combination thereof. Also, although at times the discussion herein is for elongated ferromagnetic objects 112 passing through tubular yoke 102, the discussion equally applies to tubular yoke 102 passing over elongated ferromagnetic objects 112.

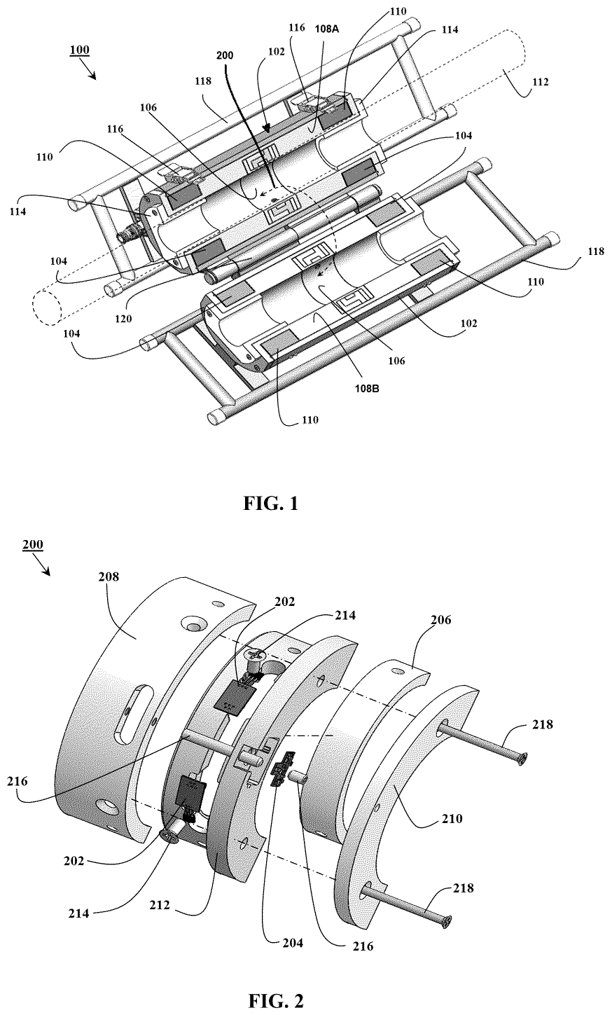

Referring to FIG. 1, concentrator 100 comprises tubular yoke 102, a pair of magnet assemblies 104 and magnetic flux concentrator 106. Tubular yoke 102 defines an outer housing to concentrator 100. In a preferred embodiment, mild steel material is used for tubular yoke 102, but any ferromagnetic material with similar properties may also be used such as, but not limited to, silicon steel, tungsten steel and other forms of carbon steel. Also, the length of tubular yoke 102 is in typically the range of 200 mm to 300 mm. In an embodiment, tubular yoke 102 includes two C-Shaped elongated structures (collectively referred to as “108”): first C-shaped elongated structure 108A and second C-shaped elongated structure 108B. These are typically are joined together by hinge 120 which is provided for coupling C-shaped elongated structures 108 together to form tubular yoke 102. In an embodiment, hinge 120 comprises a barrel hinge, but any kind of hinge or other similar coupling arrangements may also be implemented in concentrator 100.

The pair of magnet assemblies 104 are typically placed at both ends of tubular yoke 102, as shown in FIG. 1. The shape of magnet assemblies 104 is typically complementary to tubular yoke 102 such that magnet assemblies 104 sit properly into tubular yoke 102, e.g., accepted within a predetermined portion of tubular yoke 102 without obstructing an interior annulus of tubular yoke 102. In an embodiment, a first magnet assembly 104 is disposed at least partially within first C-shaped elongated structure 108A proximate a first end of first C-shaped elongated structure 108A and a second magnet assembly 104 is distally disposed at least partially within first C-shaped elongated structure 108A proximate a second end of first C-shaped elongated structure 108A. The pair of magnet assemblies 104 induce magnetic flux in ferromagnetic object 112 as it passes through tubular yoke 102 or as tubular yoke 102 passes over and around ferromagnetic object 112. In other words, as elongated ferromagnetic object 112 passes through tubular yoke 102 (or as tubular yoke 102 passes over elongated ferromagnetic object 112) magnet assemblies 104 saturate elongated ferromagnetic object 112. In an embodiment, the distance between magnetic assemblies 104 is in the range of around 180 to around 220 mm for elongated ferromagnetic objects 112 having a diameter in the range of around 30 mm to around 43 mm.

In an embodiment, each pair of magnet assemblies 104 comprises two semi-circular magnets 110, each disposed in a predetermined section of C-shaped elongated structure 108 of concentrator 100. In view of this, in embodiments concentrator 100 can comprise four radially charged semi-circular magnets 110 as a whole with two semi-circular magnets 110 on each end of concentrator 100. In embodiments, a third magnet assembly 104 may be typically disposed at least partially within second C-shaped elongated structure 108B proximate a first end of second C-shaped elongated structure 108B diametrically opposed to the first magnet assembly 104 and configured to diametrically align with the first magnet assembly 104 when first C-shaped elongated structure 108A is aligned proximate second C-shaped elongated structure 108B. A fourth magnet assembly 104 may also be typically distally disposed at least partially within second C-shaped elongated structure 108B proximate a second end of second C-shaped elongated structure 108B diametrically opposed to the second magnet assembly 104 and configured to diametrically align with the second magnet assembly 104 when first C-shaped elongated structure 108A is aligned proximate second C-shaped elongated structure 108B.

As a result, magnetic flux lines are formed within concentrator 100, forming a loop by covering magnet assemblies 104 and passing through tubular yoke 102, magnet assemblies 104 on one end of tubular yoke 102, and ferromagnetic object 112. In this manner, ferromagnetic object 112 passing through concentrator 100, or concentrator 100 passing over ferromagnetic object 112, may be saturated by the induced magnetic flux.

Typically, strong magnets are required in concentrator 100 to adequately saturate ferromagnetic object 112. In an embodiment, neodymium-iron-boron Nd—Fe—B magnet material is used. However, it would be obvious for the skilled person to use any other material of magnets having high remanence, coercivity, and quality factors such as, but not limited to, alnico, alcomax,

BaFe₁₂O₉, Cecuco₅, SmCo₅, or Sm₂Co₁₇. In addition, the high quality factor value implies that magnetic flux is obtained with smaller volume of the material. In addition, high quality factor makes concentrator 100 lighter and more compact. Generally, magnets are graded by the maximum energy the magnet produces. Typically, the higher the magnet grade, the higher the corresponding strength of the magnet. In accordance with one embodiment of the disclosure, the grade of magnet used is N48 but may be selected from the range of, but not limited to, N35 to N52.

In an embodiment, magnetic flux concentrator 106 is placed in a center of concentrator 100. Specifically, magnetic flux concentrator 106 is typically placed between magnet assemblies 104 within tubular yoke 102, as shown in FIG. 1. Magnetic flux concentrator 106 is configured to concentrate or capture leaked magnetic flux emanated from elongated ferromagnetic object 112 passing through concentrator 100, or concentrator 100 passing over ferromagnetic object 112. Generally, due to defects in elongated ferromagnetic object 112 magnetic flux starts to leaks out of distorted sections of elongated ferromagnetic object 112. Thus, in order to capture leaked magnetic flux, magnetic flux concentrator 106 may be disposed in a center of concentrator 100. Furthermore, magnetic flux concentrator 106 may be used to provide the nature and characteristics of defects within elongated ferromagnetic object 112 by converting leaked magnetic flux into readable voltage signals. Due to this, magnetic flux concentrator 106 is circumscribed around elongated ferromagnetic object 112 in concentrator 100 for cleanly capturing leaked magnetic flux.

Referring to FIG. 2, magnetic flux concentrator 106 is typically segmented with flux concentrator 200 which may comprise two or more pieces which join with each other to form a ring shaped structure of magnetic flux concentrator 106 that surrounds elongated ferromagnetic object 112. C-shaped flux concentrator 200 or magnetic flux concentrator 106 typically comprise one or more local fault (LF) sensors 202 and one or more loss of metallic area (LMA) sensors 204. LF sensor 202 may be provided to sense localized discontinuities in elongated ferromagnetic object 112. Similarly, LMA sensor 204 may be used to sense distributed discontinuities in elongated ferromagnetic object 112. In an embodiment, both LF sensor 202 and LMA sensor 204 are Hall Effect type sensors disposed within magnetic flux concentrator 106 and thus magnetic flux concentrator 106 is preferably positioned in the center of concentrator 100.

In an embodiment, C-shaped flux concentrator 200 comprises C-strip 206, bracket with first side flange 208, second side flange 210, and filler component 212. Further, C-strip 206, bracket with first side flange 208, and second side flange 210 typically comprise a ferromagnetic material. In an embodiment, the material of C-strip 206, bracket with first side flange 208, and second side flange 210 is a μ metal and/or a mild steel where the μ metal provides a low reluctance path for magnetic flux. Typically, the μ metal is a nickel-iron soft ferromagnetic alloy with very high permeability.

In addition, bracket with first side flange 208 is typically machined as single component. Also, while assembling C-shaped flux concentrator 200 filler component 212 is typically sandwiched between bracket with first side flange 208 and second side flange 210. C-strip 206 is typically assembled with a shaped that is complementary to an internal curvature of C-shaped flux concentrator 200.

The components of magnetic flux concentrator 106, i.e., C-strip 206, bracket with first side flange 208, second side flange 210, and filler component 212, are typically assembled together to form a C-shaped flux concentrator 200 by using one or more fasteners 218. In addition, C-shaped flux concentrator 200 may be configured to be press fitted into tubular yoke 102.

In an embodiment, LF sensor 202 and LMA sensor 204 are disposed in filler component 212. Further, filler component 212 is selected such that its component material offers minimal reluctance and is rigid enough to hold the metallic components of magnetic flux concentrator 106. In an embodiment, acetal DELRIN® material is selected for filler component 212. However, it is obvious for the person skilled in the art to use any other material possessing similar properties with respect to the acetal material. In an embodiment, the material of filler component 212 is selected from, but not limited to, polyethylene terephthalate (PET), polyethylene (PE), high-density polyethylene (HDPE), polyvinyl chloride (PVC), polypropylene (PP), polystyrene (PS), or acrylonitrile butadiene styrene (ABS).

In an embodiment, magnetic flux concentrator 106 comprises a channelizing unit for channelizing the magnetic flux onto sensors 202 and 204. The channeling unit typically comprises a plurality of pins 214 and 216, e.g., first pin 214 and second pin 216. First pin 214 and second pin 216 channelize leaked magnetic flux captured by magnetic flux concentrator 106 onto LF sensor 202 and LMA sensor 204.

The plurality of pins 214 and 216 are placed adjacent to sensors 202 and 204 and positioned proximate to, and protruding with respect to, LF sensor 202 and LMA sensor 204, e.g., first pin 214 is positioned in vicinity of LF sensor 202 and second pin 216 is positioned in vicinity of LMA sensor 202. Typically, first pin 214 is positioned perpendicular to an axis defined by elongated ferromagnetic object 112 disposed within concentrator 100 and second pin 216 is positioned parallel to the axis defined by elongated ferromagnetic object 112. In a further embodiment, second pin 216 is positioned perpendicular to the axis defined by elongated ferromagnetic object 112.

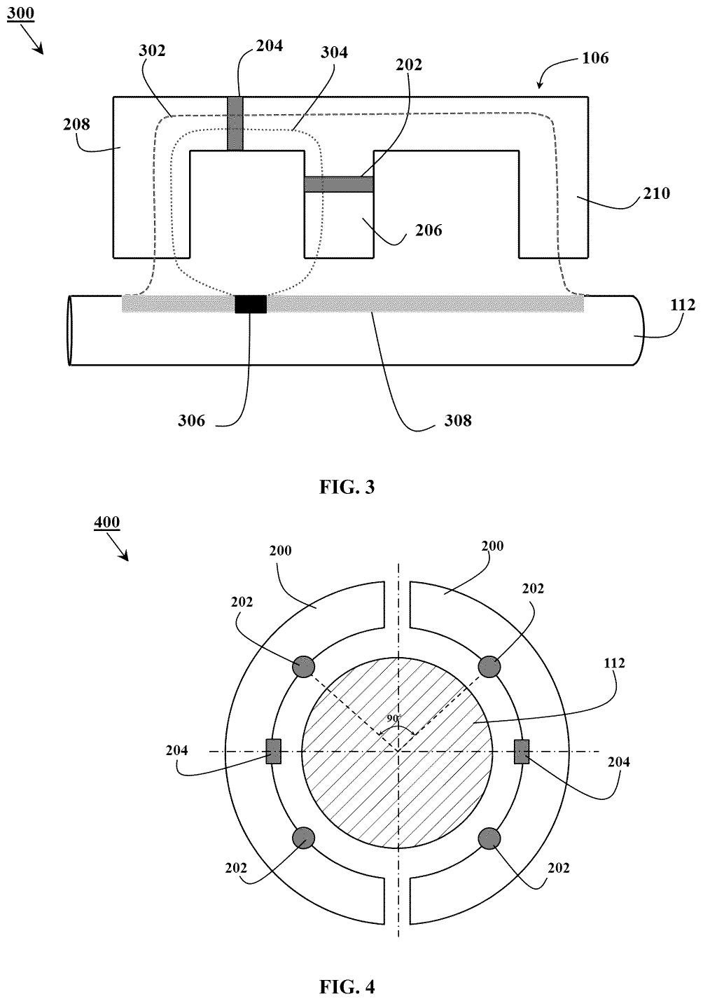

Referring to FIG. 3, C-shaped flux concentrator 200 may comprise LF sensor 202 and LMA sensor 204 as indicated in magnetic flux concentrator 106. LF sensor 202 and LMA sensor 204 may also be positioned at specific angles in magnetic flux concentrator 106 in order to efficiently capture the leaked magnetic flux from elongated ferromagnetic object 112. In an embodiment, to accurately capture leaked magnetic flux LF sensor 202 and LMA sensor 204 with a predetermined level of precision and need to be positioned perpendicular to the magnetic flux.

As already explained, two types of discontinuities are encountered in elongated ferromagnetic object 112: local discontinuities 306 and distributed discontinuities 308. Local discontinuities 306 are captured by LF sensor 202 and distributed discontinuities 308 are captured by LMA sensor 204. As can be seen in FIG. 3, magnetic flux 302 leaked due to distributed discontinuity 308 in elongated ferromagnetic object 112 enters magnetic flux concentrator 106 through first side flange of bracket 208 and exits magnetic flux concentrator 106 through second side flange 210 or vice versa. Thus, in order to capture the magnetic flux 302, LMA sensor 204 is typically positioned perpendicular to magnetic flux 302. Similarly, the leaked magnetic flux 304 due to local discontinuities 306 enters magnetic flux concentrator 106 though C-strip 206 and exits through first side flange 208 or second side flange 210. Thus, LF sensor 202 may be positioned perpendicular to the path of leaked magnetic flux 304.

For the same reasons first pin 214 (FIG. 2) is typically positioned perpendicular to elongated ferromagnetic object 112 such that the leaked magnetic flux 304 line travels in the direction of first pin 214 that is parallel to first pin 214. Thus, when the first pin 214 is along the direction of magnetic flux 304 maximum flux is captured and thus is channelized onto LF sensor 202. Similarly, the second pin 216 (FIG. 2) is typically placed along the direction of leaked magnetic flux 302 to capture maximum flux and channelizes magnetic flux 302 onto LMA sensor 204.

Referring to FIG. 4, in a further embodiment magnetic flux concentrator 106 comprises two LMA sensors 204 and four LF sensors 202. Furthermore, each LF sensor 202 is typically positioned at a gap of 90° relative to another LF sensor 202. Thus, four LF sensors 202 may be used to provide 360° coverage of leaked magnetic flux. In the similar manner, two LMA sensors 204 may be placed within magnetic flux concentrator 106 with a gap of 180° within each LMA sensor 204. In an embodiment, each LF sensor 202 and LMA sensor 204 can be placed anywhere within magnetic flux concentrator 106 at an angular gap of 90° and 180° respectively in order to capture 360° coverage of the leaked magnetic flux from elongated ferromagnetic object 112. In an embodiment, the distance from a surface of elongated ferromagnetic object 112 and LF sensor 202 and LMA sensor 204 is in the range of around 15 mm to around 30 mm. In an embodiment, LF sensor 202 and LMA sensor 204 may be placed anywhere on the flange or bracket of magnetic flux concentrator 106.

Referring again to FIG. 1, concentrator 100 may further comprise liner 114 which may be secured at each end of tubular yoke 102 such as by being secured at an internal curvature of tubular yoke 102 at each end of tubular yoke 102. Liner 114 allows centering of elongated ferromagnetic object 112 within concentrator 100 while inserting it into concentrator 100. Thus, as per the diameter of elongated ferromagnetic object 112, a similar diameter liner can be used. In an embodiment, the diameter of elongated ferromagnetic object 112 that can be accommodated in concentrator 100 is in the range of around 30 mm to around 43 mm. In addition, the material of liner 114 is typically DELRIN® although it may comprise polyethylene terephthalate (PET), polyethylene (PE), high-density polyethylene (HDPE), polyvinyl chloride (PVC), polypropylene (PP), polystyrene (PS), acrylonitrile butadiene styrene (ABS), or the like, or a combination thereof.

In embodiments, concentrator 100 may comprise latch 116 to latch two halves of tubular yoke 102. In certain embodiments, two C-shaped elongated structures 108A, 108B of tubular yoke 102 may be secured to each other and latched using latch 116, such as while performing inspection of elongated ferromagnetic object 112.

In embodiments, concentrator 100 further includes hand grill 118 adapted to ease handling of concentrator 100.

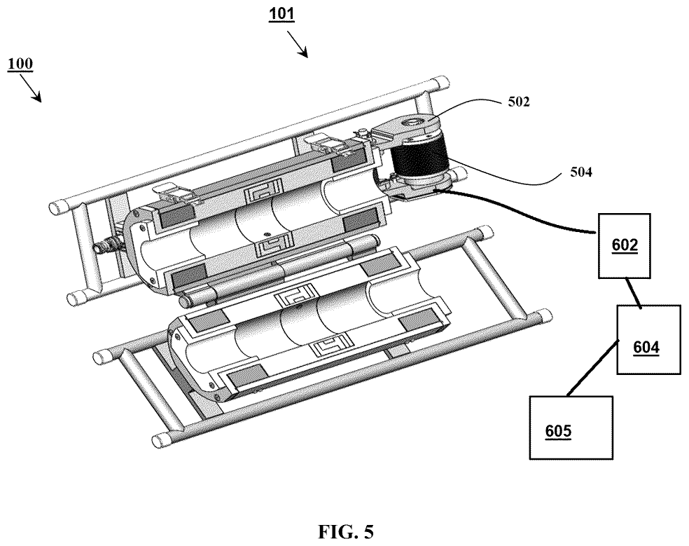

Referring to FIG. 5, a system including concentrator 100, which is as described above, may also include one or more encoder assemblies 502, each of which may further comprise wheel 504 configured to rotate as elongated ferromagnetic object 112 (FIG. 1) travels through concentrator 100. Encoder assembly 502 helps in locating the exact location of the defect on elongated ferromagnetic object 112 (FIG. 1). Typically, LF sensors 202 and LMA sensors 204 (FIG. 2) provide information about the nature and character of the defect and encoder assembly 502 provides information of location of the defect. In one embodiment of the invention, the feed rate of elongated ferromagnetic object 112 is in the range of 0.25 to 1.25 meters/second.

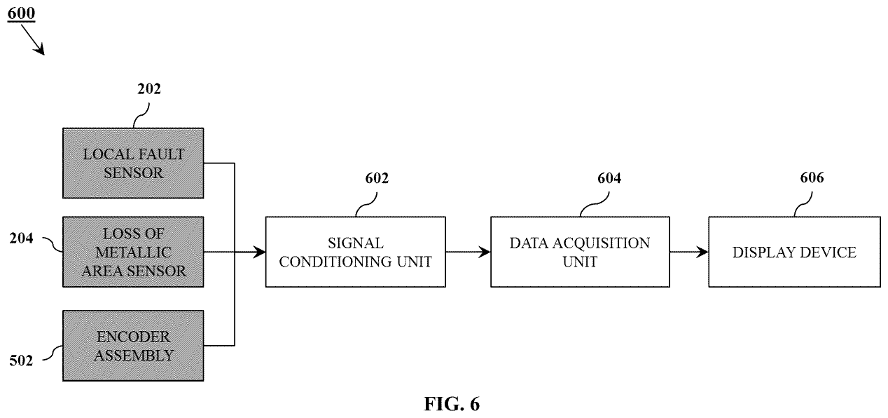

In the operation of an exemplary embodiment, referring to FIG. 6, data are sensed by and gathered from LF sensor 202, LMA sensors 204, and encoder assembly 502. LF sensors 202 and LMA sensors 204 are as described above and typically provide output in an analog form which can then be converted into digital form by encoder assembly 502 or by using analog to digital converters (not shown in the figures). Digital signals from encoder assembly 502 are sent to signal conditioning unit 602 which typically processes, and may further enrich, the received digital signals. Further, signal conditioning unit 602 may further process data using one or more filters (not shown in figures) such as to reduce noise from or within the signals and convert the data into readable and compatible form for data acquisition unit 604 which may use or otherwise convert the signals into readable format for display on display device 604.

The foregoing disclosure and description of the inventions are illustrative and explanatory. Various changes in the size, shape, and materials, as well as in the details of the illustrative construction and/or an illustrative method may be made without departing from the spirit of the invention.

1. A concentrator for inspecting defects in a ferromagnetic object, comprising:
a) a tubular yoke comprising a ferromagnetic material, the tubular yoke comprising:
i) a first C-shaped elongated structure; and
ii) a second C-shaped elongated structure;
b) a hinge connected to the first C-shaped elongated structure proximate a first edge of the first C-shaped elongated structure and a first edge of the second C-shaped elongated structure, the hinge configured to allow the first C-shaped elongated structure to secure against the second C-shaped elongated structure and define an interior annulus therethrough;
c) a predetermined set of magnet assemblies, each magnet assembly configured to be accepted within a predetermined portion of the tubular yoke without obstructing the interior annulus, each magnet assembly comprising a high remanence, coercivity and quality factor magnet, the predetermined set of magnet assemblies comprising:
i) a first magnet assembly disposed at least partially within the first C-shaped elongated structure proximate a first end of the first C-shaped elongated structure; and
ii) a second magnet assembly distally disposed at least partially within the first C-shaped elongated structure proximate a second end of the first C-shaped elongated structure; and
d) a flux concentrator disposed at least partially within the tubular yoke and comprising a C-shape that does not obstruct the interior annulus.

2. The concentrator for inspecting defects in a ferromagnetic object of claim 1, wherein the predetermined set of magnet assemblies further comprises:
a) a third magnet assembly disposed at least partially within the second C-shaped elongated structure proximate a first end of the second C-shaped elongated structure diametrically opposed to the first magnet assembly and configured to diametrically align with the first magnet assembly when the first C-shaped elongated structure is aligned proximate the second C-shaped elongated structure; and
b) a fourth magnet assembly distally disposed at least partially within the second C-shaped elongated structure proximate a second end of the second C-shaped elongated structure diametrically opposed to the second magnet assembly and configured to diametrically align with the second magnet assembly when the first C-shaped elongated structure is aligned proximate the second C-shaped elongated structure.

3. The concentrator for inspecting defects in a ferromagnetic object of claim 1, wherein the hinge comprises a barrel hinge.

4. The concentrator for inspecting defects in a ferromagnetic object of claim 1, wherein each magnet comprises a radially charged, semi-circular magnet comprising a portion exposed to an exterior portion of its respective C-shaped elongated structure.

5. The concentrator for inspecting defects in a ferromagnetic object of claim 1, wherein the flux concentrator is disposed proximate a center of the concentrator intermediate the predetermined set of magnet assemblies.

6. The concentrator for inspecting defects in a ferromagnetic object of claim 1, wherein the flux concentrator comprises:
a) a first C-shaped flux concentrator;
b) a second C-shaped flux concentrator which, when joined with the first C-shaped flux concentrator, forms a ring-shaped structure configured to surround an elongated ferromagnetic object passing through the concentrator;
c) a local fault (LF) sensor configured to sense a localized discontinuity in the elongated ferromagnetic object; and
d) a loss of metallic area (LMA) sensor configured to sense a distributed discontinuity in the elongated ferromagnetic object.

7. The concentrator for inspecting defects in a ferromagnetic object of claim 6, wherein the local fault (LF) sensor and the loss of metallic area (LMA) sensor are positioned at a predetermined set of specific angles within the flux concentrator assembly sufficient to capture leaked magnetic flux from the elongated ferromagnetic object.

8. The concentrator for inspecting defects in a ferromagnetic object of claim 6, wherein:
a) the local fault (LF) sensor is disposed at least partially within the filler component; and
b) the loss of metallic area (LMA) sensor is disposed at least partially within the filler component.

9. The concentrator for inspecting defects in a ferromagnetic object of claim 1, wherein the flux concentrator assembly further comprises a channelizing unit for channelizing magnetic flux onto the LF sensor and the LMA sensor, the channelizing unit comprising:
a) a first pin positioned adjacent to the LF sensor and further positioned perpendicular to an axis of an elongated ferromagnetic object defined if the elongated ferromagnetic object passes through the concentrator; and
b) a second pin positioned adjacent to the LMA sensor and further positioned parallel to the axis of the elongated ferromagnetic object defined if the elongated ferromagnetic object passes through the concentrator or positioned perpendicular to an axis of the elongated ferromagnetic object, the first pin and the second pin configured to channelize leaked magnetic flux captured by the C-shaped flux concentrator onto the LF sensor and the LMA sensor.

10. The concentrator for inspecting defects in a ferromagnetic object of claim 1, further comprising a liner secured at the first end of the tubular yoke and at the second end of the tubular yoke.

11. The concentrator for inspecting defects in a ferromagnetic object of claim 10, wherein the liner is secured at an internal curvature of the tubular yoke at each end.

12. The concentrator for inspecting defects in a ferromagnetic object of claim 1, further comprising a latch configured to secure the two C-shaped elongated structures of the tubular yoke to each other.

13. A system for inspecting defects in a ferromagnetic object, comprising:
a) a concentrator for inspecting defects in a ferromagnetic object, comprising:
i) a tubular yoke comprising a ferromagnetic material, the tubular yoke comprising:
(1) a first C-shaped elongated structure; and
(2) a second C-shaped elongated structure;
ii) a hinge connected to the first C-shaped elongated structure proximate a first edge of the first C-shaped elongated structure and a first edge of the second C-shaped elongated structure, the hinge configured to allow the first C-shaped elongated structure to secure against the second C-shaped elongated structure and define an interior annulus therethrough;
iii) a predetermined set of magnet assemblies, each magnet assembly configured to be accepted within a predetermined portion of the tubular yoke without obstructing the interior annulus, each magnet assembly comprising a high remanence, coercivity and quality factor magnet, the predetermined set of magnet assemblies comprising:
(1) a first magnet assembly disposed at least partially within the first C-shaped elongated structure proximate a first end of the first C-shaped elongated structure; and
(2) a second magnet assembly distally disposed at least partially within the first C- shaped elongated structure proximate a second end of the first C-shaped elongated structure; and
iv) a flux concentrator disposed at least partially within the tubular yoke and comprising a C-shape that does not obstruct the interior annulus, the flux concentrator assembly comprising:
(1) a first C-shaped flux concentrator;
(2) a second C-shaped flux concentrator which, when joined with the first C-shaped flux concentrator, forms a ring-shaped structure configured to surround an elongated ferromagnetic object passing through the concentrator;
(3) a local fault (LF) sensor configured to sense a localized discontinuity in the elongated ferromagnetic object; and
(4) a loss of metallic area (LMA) sensor configured to sense a distributed discontinuity in the elongated ferromagnetic object;
b) an encoder assembly operatively in communication with the local fault (LF) sensor and the loss of metallic area (LMA) sensor, the encoder assembly comprising a wheel configured to rotate as the elongated ferromagnetic object travels through the concentrator;
c) a signal conditioning unit operatively in communication with the encoder assembly;
d) a data acquisition unit operatively in communication with the signal conditioning unit; and
e) a display device operatively in communication with the data acquisition unit.

14. A method of data acquisition and processing regarding a characteristic of a ferromagnetic object, comprising:
a) traversing the ferromagnetic object with a system for inspecting defects in a ferromagnetic object, comprising:
i) a concentrator for inspecting defects in a ferromagnetic object, comprising:
(1) a tubular yoke comprising a ferromagnetic material, the tubular yoke comprising:
(a) a first C-shaped elongated structure; and
(b) a second C-shaped elongated structure;
(2) a hinge connected to the first C-shaped elongated structure proximate a first edge of the first C-shaped elongated structure and a first edge of the second C-shaped elongated structure, the hinge configured to allow the first C-shaped elongated structure to secure against the second C-shaped elongated structure and define an interior annulus therethrough;
(3) a predetermined set of magnet assemblies, each magnet assembly configured to be accepted within a predetermined portion of the tubular yoke without obstructing the interior annulus, each magnet assembly comprising a high remanence, coercivity and quality factor magnet, the predetermined set of magnet assemblies comprising:
(a) a first magnet assembly disposed at least partially within the first C-shaped elongated structure proximate a first end of the first C-shaped elongated structure; and
(b) a second magnet assembly distally disposed at least partially within the first C-shaped elongated structure proximate a second end of the first C-shaped elongated structure; and
(4) a flux concentrator disposed at least partially within the tubular yoke and comprising a C-shape that does not obstruct the interior annulus, the flux concentrator assembly comprising:
(a) a first C-shaped flux concentrator;
(b) a second C-shaped flux concentrator which, when joined with the first C-shaped flux concentrator, forms a ring-shaped structure configured to surround an elongated ferromagnetic object passing through the concentrator;
(c) a local fault (LF) sensor configured to sense a localized discontinuity in the elongated ferromagnetic object; and
(d) a loss of metallic area (LMA) sensor configured to sense a distributed discontinuity in the elongated ferromagnetic object;
ii) an encoder assembly operatively in communication with the local fault (LF) sensor and the loss of metallic area (LMA) sensor;
iii) a signal conditioning unit operatively in communication with the encoder assembly;
iv) a data acquisition unit operatively in communication with the signal conditioning unit; and
v) a display device operatively in communication with the data acquisition unit;
b) using the local fault (LF) sensor and the loss of metallic area (LMA) sensor to obtain data related to a flaw or discontinuity in the ferromagnetic object by using the pair of magnet assemblies to induce magnetic flux in the ferromagnetic object as it passes through the tubular yoke by having the magnet assemblies saturate the elongated ferromagnetic object with a magnetic field;
c) providing the obtained data to the encoder assembly;
d) creating a set of digital data from the encoder assembly using the obtained data; and
e) providing the set of digital data from the encoder assembly to a signal conditioning unit as a digital signal.

15. The method of data acquisition and processing regarding a characteristic of a ferromagnetic object of claim 14, further comprising:
a) using the signal conditioning unit to process the set of digital data received at the signal conditioning unit;
b) converting the processed received digital signal into a readable, compatible form;
c) supplying the readable, compatible form to a data acquisition unit; and
d) using the data acquisition unit to convert the readable, compatible form into a readable format displayed on a display device.

16. The method of data acquisition and processing regarding a characteristic of a ferromagnetic object of claim 14, wherein:
a) output from the local fault (LF) sensors and the loss of metallic area (LMA) sensors comprises an analog signal; and
b) the analog signal is converted into digital form using an analog to digital converter.

17. The method of data acquisition and processing regarding a characteristic of a ferromagnetic object of claim 14, wherein the flux concentrator assembly captures leaked magnetic flux around the elongated ferromagnetic object, thereby enabling 360 degree coverage of the defects.

18. The method of data acquisition and processing regarding a characteristic of a ferromagnetic object of claim 14, wherein the flux concentrator comprises a channelizing unit for channelizing the magnetic flux on to the sensors, the channeling unit comprising a plurality of pins placed adjacent to the sensors the pins, the method further comprising allow channelizing of the magnetic flux directly on to the sensors to enhance sensitivity and reliability of the concentrator.
